(19) United States
(12) Patent Application Publication
(10) Pub. No.: US 2026/0050801 A1
(43) Pub. Date: Feb. 19, 2026

(54) METHOD AND DEVICE WITH KNOWLEDGE MAP GENERATION

(71) Applicants: Samsung Electronics Co., Ltd., Suwon-si (KR); Seoul National University R&DB Foundation, Seoul (KR)

(72) Inventors: SungHwan JEON, Suwon-si (KR); Hyunjong KIM, Seoul (KR); Sohhyung PARK, Seoul (KR); Suyeon LEE, Seoul (KR); Sungzoon CHO, Seoul (KR)

(73) Assignees: Samsung Electronics Co., Ltd., Suwon-si (KR); Seoul National University R&DB Foundation, Seoul (KR)

(21) Appl. No.: 19/296,006

(22) Filed: Aug. 11, 2025

(30) Foreign Application Priority Data
Aug. 14, 2024 (KR) 10-2024-0109320

(51) Int. Cl. G06N 5/022; G06F 16/35; G06F 16/36; G06F 40/205; G06F 40/284

(52) U.S. Cl. CPC G06N 5/022; G06F 16/35; G06F 16/374; G06F 40/205; G06F 40/284

(57) ABSTRACT

A method for generating a knowledge map includes: extracting, as main entities, words by applying a key-phrase-extraction language model to the document; extracting a verb representing a relationship between main entities as a relational verb by performing dependency parsing on a sentence including the main entities; clustering the extracted relational verb into clusters to generate a relational verb dictionary; generating a knowledge triplet including a first entity and a second entity among the main entities and a cluster identifier indicating a relationship between the first entity and the second entity based on the relational verb dictionary; and generating the knowledge map based on the knowledge triplet.

### CROSS-REFERENCE TO RELATED APPLICATIONS

This application claims priority to and the benefit of Korean Patent Application No. 10-2024-0109320 filed at the Korean Intellectual Property Office on Aug. 14, 2024, the entire contents of which are incorporated herein by reference.

### BACKGROUND

### 1. Field

The present disclosure relates to a method and a device with knowledge map generation.

### 2. Description of Related Art

In the modern information society, the amount of knowledge is exponentially increasing, and the need to efficiently manage and utilize the knowledge is becoming increasingly important. In particular, a technology for extracting meaningful information from a large document database and systematically organizing the meaningful information is becoming essential in various industry fields. In this regard, a knowledge map is used as an important tool for visually expressing important entities within a specific domain and a relationship between the entities and for helping to clearly understand the connection structure between pieces of information (e.g., about the entities).

With traditional knowledge map generation methods, document data is analyzed mainly by hand or by a simple algorithm, and the knowledge map is created based on the analyzed document data. However, these methods have difficulty ensuring high accuracy and efficiency for a large amount of document data, and may have limitations in handling complex information structure.

With the development of natural language processing technology and artificial intelligence technology, a method for automatically extracting and structuring important information within a document has recently been under development. Such technologies provide high efficiency in processing a large amount of data, and may play a key role in generating knowledge maps.

### SUMMARY

A problem that may be solved by the information disclosed herein is generating a knowledge map capable of automatically building a knowledge ontology and a relational knowledge map by extracting knowledge specific to a specific field when a knowledge ontology is not available.

In one general aspect, a method for generating a knowledge map includes: determining a domain to generate the knowledge map; receiving a document selected as belonging to the determined domain from a document database; extracting, as main entities, a set of words from the received document by applying a key-phrase-extraction language model to the document; extracting, as a relational verb, from the received document, a verb representing a relationship between the main entities by performing dependency parsing on a sentence including the main entities; clustering, by a large language model, the extracted relational verb into a clusters to generate a relational verb dictionary; generating a knowledge triplet including a first entity and a second entity among the main entities and a cluster identifier of one of the clusters, the cluster identifier indicating a relationship between the first entity and the second entity based on the relational verb dictionary; generating the knowledge map based on the knowledge triplet; and recording the generated knowledge map in the storage medium.

The generating the knowledge triplet using the cluster identifier designated in the relational verb dictionary may be performed based on the verb indicating that the relationship between the first entity and the second entity is included in the relational verb dictionary; and the method may further include: extracting a second relational verb from the sentence in the received document, the second verb representing a second relationship between a third main entity and a fourth main entity among the main entities; and generating a second knowledge triplet used to generate the knowledge map by using a cluster identifier obtained by inputting a few-shot prompt into the large language model based on the second verb indicating that the second relationship between the third and fourth entities is not included in the relational verb dictionary.

The generated knowledge triplet and the second knowledge triplet may be stored in a knowledge triplet database, and the generating of the second knowledge triplet using the cluster identifier obtained by inputting the few-shot prompt into the large language model based on the second verb indicating the relationship between the third and fourth entities is not included in the relational verb dictionary may include: calculating a first similarity between the third entity and an entity of a head node of a second knowledge triplet stored in the knowledge triplet database, calculating a second similarity between the fourth entity and an entity of a tail node of the second knowledge triplet stored in the knowledge triplet database, designating the second knowledge triplet as a few-show example based on the first similarity and the second similarity exceeding a predetermined threshold value, and adding the few-shot example to the few-shot prompt.

The designating of the second knowledge triplet as the few-shot example may include: designating K knowledge triplets in which the first similarity and the second similarity exceed a predetermined threshold value and a sum of the first similarity and the second similarity is selected in a descending order among the knowledge triplets stored in the knowledge triplet database as a few-shot example.

The adding of the few-shot example to the few-shot prompt may include: selecting a representative example for each cluster from the knowledge triplet stored in the knowledge triplet database; and adding the representative examples to the few-shot prompt together with the few-shot example.

The document may be preprocessed by tokenization that separates the document into tokens that are a minimum unit of analysis based on an individual sentence, an individual word, and a subword and lemmatization that converts words of the document into a basic form.

The determining of the domain may include: determining that a domain setting value is a first value representing a first domain among multiple domains and determining the first domain to generate the knowledge map as the first domain according to the first value, and the extracting of the word or the set of words as the main entities may include extracting the main entities by applying a first key-phrase-extraction language model that is trained to extract a key phrase from the document belonging to the first domain to the document.

The determining of the domain may include: determining that the domain setting value is a second value representing a second domain and determining the second domain to generate the knowledge map as the second domain according to the second value, and the extracting of the word or the set of words as the main entity may include: extracting the main entities by applying a second key-phrase-extraction language model that is trained to extract a key phrase from the document belonging to the second domain to the document.

The generating of the knowledge triplet may include: storing a first knowledge triplet generated based on a first relational verb dictionary based on the main entities extracted in relation to the first domain in a first knowledge triplet database; and storing a second knowledge triplet generated based on a second relational verb dictionary based on the main entities extracted in relation to the second domain in a second knowledge triplet database.

The generating of the knowledge map may include: generating the knowledge map based on the first knowledge triplet database if the domain in which the knowledge map is to be generated is the first domain; and generating the knowledge map based on the second knowledge triplet database if the domain in which the knowledge map is to be generated is the second domain.

In another general aspect, a method for generating a knowledge map includes: receiving a document through an input/output interface of a computing device; extracting, as main entities, a set of words from the received document by applying a key-phrase-extraction language model to the document; extracting, as a relational verb, from the received document, a first verb representing a first relationship between the main entities and a second verb representing a second relationship between the main entities by performing dependency parsing on a sentence including the main entities; clustering, by a large language model, the extracted relational verbs into clusters to generate a relational verb dictionary; generating a first knowledge triplet using a first cluster identifier designated in the relational verb dictionary based on a first verb indicating a first relationship between a first entity and a second entity among the main entities being included in the relational verb dictionary; generating a second knowledge triplet using a second cluster identifier obtained by inputting a few-shot prompt into the large language model based on the verb indicating the second relationship between a third entity and a fourth entity among the entities is not included in the relational verb dictionary; generating the knowledge map based on the knowledge triplet; and recording the generated knowledge map in a storage medium of the computing device.

The generated knowledge triplet may be stored in a knowledge triplet database, and the generating of the second knowledge triplet using the second cluster identifier obtained by inputting the few-shot prompt into the large language model based on the second verb indicating the second relationship between the third entity and the fourth entity is not included in the relational verb dictionary may include: calculating a first similarity between the third entity and an entity of a head node of a knowledge triplet stored in the knowledge triplet database, calculating a second similarity between the fourth entity and an entity of a tail node of the knowledge triplet stored in the knowledge triplet database, designating, as a few-shot example, the knowledge triplet in which the first similarity and the second similarity exceed a threshold value among knowledge triplets stored in the knowledge triplet database, and adding the few-shot example to the few-shot prompt.

The designating of the knowledge triplet as the few-shot example may include: designating K knowledge triplets in which the first similarity and the second similarity exceed a predetermined threshold value and a sum of the first similarity and the second similarity is selected in a descending order among the knowledge triplets stored in the knowledge triplet database as a few-shot example.

The adding of the few-shot example to the few-shot prompting may include: selecting representative examples for the respective clusters from the knowledge triplets stored in the knowledge triplet database; and adding the representative examples to the few-shot prompt together with the few-shot example.

The document may be preprocessed by tokenization that separates the document into tokens that are a minimum unit of analysis based on an individual sentence, an individual word, and a subword and lemmatization that converts words of the document into a basic form.

In another general aspect, a device for generating a knowledge map includes: one or more memory devices; and one or more processors that generate the knowledge map by executing instructions stored in the one or more memory devices, wherein the instructions are executed to cause, by the device, determining a domain to generate the knowledge map, receiving a document selected from a document database based on belonging to the domain, extracting, as main entities, a set of words by applying a key-phrase-extraction language model to the document, extracting a verb representing a relationship between main entities as a relational verb in the document by performing dependency parsing on a sentence including the main entities, clustering, by the large language model, the extracted relational verbs into clusters to generate a relational verb dictionary, generating a knowledge triplet including a first entity and a second entity among the main entities and a cluster identifier indicating a relationship between the first entity and the second entity based on the relational verb dictionary, generating the knowledge map based on the knowledge triplet, and recording the generated knowledge map in the storage medium are performed.

The generating the knowledge triplet using the cluster identifier designated in the relational verb dictionary may be performed based on the verb indicating that the relationship between the first entity and the second entity is included in the relational verb dictionary; and wherein the instructions may further cause: extracting a second relational verb from the sentence in the received document, the second verb representing a second relationship between a third main entity and a fourth main entity among the main entities; and generating a second knowledge triplet used to generate the knowledge map by using a cluster identifier obtained by inputting few-shot prompt into the large language model based on the second verb indicating that the second relationship between the third and fourth entities is not included in the relational verb dictionary.

The generated knowledge triplet and the second knowledge triplet may be stored in a knowledge triplet database, and the generating of the second knowledge triplet using the cluster identifier obtained by inputting the few-shot prompt into the large language model based on the second verb indicating the relationship between the third and fourth entities is not included in the relational verb dictionary may include: calculating a first similarity between the third entity and an entity of a head node of a second knowledge triplet stored in the knowledge triplet database, calculating a second similarity between the fourth entity and an entity of a tail node of the second knowledge triplet stored in the knowledge triplet database, designating the second knowledge triplet as a few-show example based on the first similarity and the second similarity exceeding a predetermined threshold value, and adding the few-shot example to the few-shot prompt.

The designating of the second knowledge triplet as the few-shot example may include: designating K knowledge triplets in which the first similarity and the second similarity exceed a predetermined threshold value and a sum of the first similarity and the second similarity is selected in a descending order among the knowledge triplets stored in the knowledge triplet database as a few-shot example.

The adding of the few-shot example to the few-shot prompt may include: selecting a representative example for each cluster from the knowledge triplet stored in the knowledge triplet database; and adding the representative examples to the few-shot prompt together with the few-shot example.

Other features and aspects will be apparent from the following detailed description, the drawings, and the claims

### BRIEF DESCRIPTION OF THE DRAWINGS

FIG. 1 shows a device for generating a knowledge map according to one or more embodiments.

FIGS. 2 to 7 show a detailed process of generating the knowledge map according to one or more embodiments.

FIG. 8 shows a method for generating the knowledge map according to one or more embodiments.

FIG. 9 shows a detailed process of generating the knowledge map according to one or more embodiments.

FIG. 10 shows a method for generating the knowledge map according to one or more embodiments.

FIG. 11 shows a device for generating the knowledge map according to one or more embodiments.

FIG. 12 shows a computing device according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

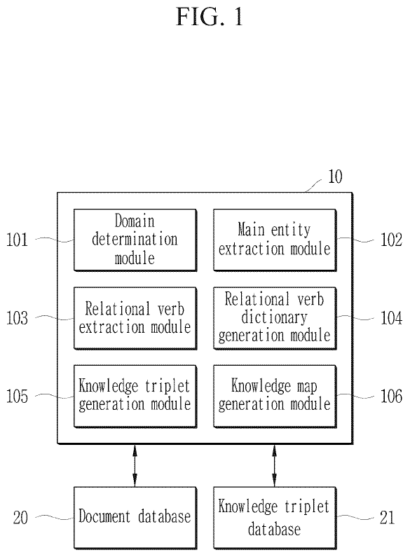

FIG. 1 shows a device for generating a knowledge map according to one or more embodiments.

In the following description, pieces of information are sometimes described in the singular. It will be appreciated that, depending on context, such singular pieces of information may be representative of multiple pieces of information of the same type being processed in similar fashion. For example, in the case of knowledge triplet generation (described further below), although generation, storage, and use of a knowledge triplet is described for a document (or corpus of documents), in practice, many knowledge triplets may be generated and used. For example, where extraction of a document is mentioned, the same process may be repeated for multiple documents.

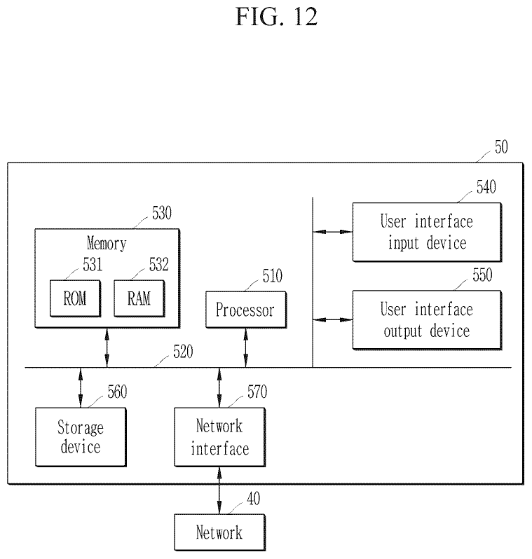

Referring to FIG. 1, the device 10 for generating the knowledge map may execute program code or instructions loaded into one or more memory devices through one or more processors. For example, the knowledge map generation device 10 may be implemented as a computing device 50 described below with respect to FIG. 12. In this case, the one or more processors may correspond to a processor 510 of the computing device 50, and the one or more memory devices may correspond to a memory 530 of the computing device 50. The program code or the instructions may be executed by the one or more processors to generate the knowledge map. As used herein, the term “module” is used to logically distinguish functions performed by the program code or the instructions.

The knowledge map may be in the form of a graph that expresses associative relationships between main entities, and may be useful as a tool for systematically structuring knowledge inherent in data that acquired from various sources. The knowledge map may be used for efficiently leveraging the structured knowledge. The knowledge map may be built so that information within a corresponding specific domain is organically interconnected (i.e., connectivity information) and so that flow and interaction of the extracted knowledge is clearly expressed based on the connectivity information. The knowledge map may be useful for understanding the contextual meaning of information in a large dataset (e.g., a document corpus) and for increasing efficiency of data analysis, decision support, information retrieval, and management, for example.

In particular, the knowledge map, when built with a focus on a specific field (e.g., thesis papers), may be used as a resource capable of providing specialized knowledge on that specific field. For example, the knowledge map, when specific to a specific industry or research field, may provide important insight for solving a problem faced by experts in the field or to may serve as a source of discovering new knowledge in the field. The specialized knowledge map may be combined with still-emerging natural language processing technologies to improve efficiency of data management and search, for example. Thus, the specialized knowledge map may provide advantages such as increasing accuracy and reliability of information and facilitating linkage and integration of data. As a result, the knowledge map may contribute to efficient utilization of information and development of innovative solutions in various industries and fields of study.

However, because technical documents such as a theses or technical manuals may include knowledge specialized in multiple fields, it may be difficult to directly apply an existing general knowledge map structure to the building of a knowledge map for the documents. Because each of the technical documents may have specialized terms and a complex structure for each field (i.e., a technical document may have content of multiple fields), each technical document may benefit from an approach different from approaches that are typically used for general documents. In particular, to build relational knowledge maps specialized for the respective fields present in the technical documents, important entities in a given field and relationships between the important entities should be individually identified and extracted with respect to the given field. Such a task may be a complex process that goes beyond extraction of simple superficial information and may involve deep understanding and analysis of semantic context in the case of multi-field technical documents.

Moreover, if no applicable knowledge ontology exists, humans may be need to be employed to manually process a large amount of data, which may be expensive and time consuming. If the problem is not solved, it may be difficult to efficiently build a knowledge map to be specialized for a specific field, and therefore practical use of the knowledge map may be limited.

The knowledge map generation device 10 may implement a method capable of building a knowledge ontology and a relational knowledge map, and the method may be capable of automatically extracting knowledge specialized in a specific field (e.g., a science and technology field) where a corresponding knowledge ontology is not already available, which may save time and cost. To this end, the knowledge map generation device 10 may include a domain determination module 101 to determine a specific domain as a target domain, a main entity extraction module 102 to extract main entities from a document/corpus, a relational verb extraction module 103 to extract verbs/predicates from the document/corpus, a relational verb dictionary generation module 104 to generate a dictionary of the verbs/predicates, a knowledge triplet generation module 105 to generate knowledge triplets from the extracted main entities and verbs/predicates, and a knowledge map generation module 106 to construct a knowledge map based on the foregoing information. These components are are described in turn below. The knowledge map generation device 10 may operate in cooperation with a document database 20 (which provides the document/corpus) and a knowledge triplet database 21 that stores the generated knowledge triplets. These components are also described below.

The domain determination module 101 may determine a domain in which a knowledge map is to be generated. As described above, the knowledge map generation device 10 may be implemented as the computing device, and the domain determination module 101 may read a domain setting value recorded in a storage medium (e.g., a memory) provided in the knowledge map generation device 10, and may thereby determine a domain in which the knowledge map is to be generated. For example, the domain setting value may be preset to a first value representing a thesis domain, for example; the value indicating that the form of the knowledge included in a science and technology field is a thesis form. In this example, the domain determination module 101 may read the domain setting value, which is the first value, and may determine therefrom that the domain in which the knowledge map is to be generated is the thesis domain. The domain determination module 101 may record data indicating that the thesis domain, for example, is the domain in which a knowledge map is to be generated in the storage medium of the knowledge map generation device 10. In another example, the domain setting value may be preset to a second value representing a technical manual domain; the second value indicates that the form in which the knowledge is included in the science and technology field is a technical manual. In this case, the domain determination module 101 may read the domain setting value with the second value, and may determine therefrom that the domain in which a knowledge map is to be generated is the technical manual domain. In this example, the domain determination module 101 may record data indicating that the target domain for generating a knowledge map is the technical manual domain. The thesis domain and the technical manual domain described above are only examples; the techniques described herein may be applied to various other domains depending on the form in which the knowledge is included. That is to say, the techniques may be applied to any field/domain.

The main entity extraction module 102 may receive/extract from the document database 20 a document determined to belong to the target domain as determined by the domain determination module 101. For example, the document database 20 may be implemented as a document-oriented database configured for storing and managing unstructured data such as entire documents, an NoSQL database, a search engine-based database, a file system-based storage, a relational database, an object database/store, a hybrid database (one implemented by a combination of at least two thereof), or the like. Documents belonging to the same domain, as well as other domains, may be stored in the document database 20 (in some cases, some of the documents may belong to multiple domains). For example, in the latter case, the main entity extraction module 102 may receive (or query for) a document belonging to the target domain (as determined by the domain determination module 101) by designating the target domain when inquiring/querying the document database 20.

In some embodiments, the received document may be preprocessed by tokenization that separates the document into tokens, which are a minimum/atomic unit of analysis based on an individual sentence, an individual word, and/or a subword and lemmatization that converts a word of the document into a basic form. The preprocessing may be performed before the document is inserted into the document database 20. Alternatively, the preprocessing may be performed after the document is output from the document database 20. Where elements of the received document are described below (e.g., words, phrases, or the like), such elements may in practice be represented as tokens, although, for descriptive purposes, mention of such tokens may be omitted.

The main entity extraction module 102 may repeatedly extract a main entity from the received document by applying a key-phrase-extraction language model to the document received from the document database 20. Specifically, when the key-phrase-extraction language model, for example, is applied to the document, a word or a set of words may be extracted, and the main entity extraction module 102 may obtain the word or the set of words as the main entity. The key-phrase-extraction language model may be used to identify a word or a phrase that it determines to be important in text included in the document. Technical documents such as theses and technical manuals may have a characteristic describing main terms in a phrase unit; a key phrase obtained by applying the key-phrase-extraction language model to the document may be treated as an entity specific to the domain (i.e., the main entity). In some embodiments, the key-phrase-extraction language model may be implemented as any of: a term frequency-inverse document frequency (TF-IDF)-based model; a bidirectional encoder representations from transformers (BERT)-based model; or the like. The TF-IDF method of identifies an important phrase by comparing a frequency of a word within a document with a frequency of appearance of the word within an entire document set, and may consider words that frequently appear in a document but rarely appear in another document as a main phrase. A BERT-based language model may extract an important phrase based on a contextual understanding. BERT-based model may understand a semantic relationship and a context of a word to identify a semantically important word and a semantically important phrase within text and may extract a key phrase based on the identified word and phrase. Key phrases from documents in the target domain may be treated as main entities.

The relational verb extraction module 103 may perform dependency parsing on a sentence, for example (other units may be used, e.g., paragraphs, pages, etc.), that includes main entities extracted by the main entity extraction module 102, and may extract therefrom a verb representing a relationship between the main entities as a relational verb (or a relative verb, or predicate). The extracted relational verb may be used as a basis for defining/constructing a relational ontology. The dependency parsing may be a technique that represents grammatical structure by analyzing a dependency relationship between words (e.g., main entities) in a sentence/phrase (or the like), for example, and may be used to grasp how a word of the sentence is connected to another word of the sentence, or may be used to represent a relationship between the word and the other word as a graph structure. The dependency relationship indicate which word of the sentence is dependent on the other word of the sentence, and may be expressed with two elements that are a head element (a main entity) and a dependent (or tail) element (another main entity). The verb extraction may be repeated for many sentences (or the like) in the received document, thus building a set of verb relationships between main entities for the document.

The relational verb dictionary generation module 104 may generate a relational verb dictionary by clustering the relational verbs extracted by the relational verb extraction module 103 into clusters. The relational verb dictionary may be a systematic structure of verbs representing relationships between main entities, and may be generated by collecting and classifying verbs representing interactions or relationships between entities in a specific domain (e.g., the target domain). In some embodiments, the relational verb dictionary generation module 104 may load a large language model (LLM) into a memory of the knowledge map generation device 10, and may generate a relational verb dictionary using the LLM. The LLM may be an artificial intelligence model (e.g., a neural network) trained based on a large dataset, and may be configured for natural language processing technology and have the ability to understand and generate a vast amount of text data. The relational verb dictionary generation module 104 may be used as a source to input, for each cluster, the top-N verbs with high frequencies (or other indications of significance), and the top-N verbs may be inserted into a prompt to build the relational verb dictionary based on the LLM. In some embodiments, the relational verb dictionary generation module 104 may designate non-clustered verbs (verbs that clustering did not place in any cluster) so that the non-clustered verbs are classified under a cluster name of “None” or the like when whose verbs are injected into the prompt.

The knowledge triplet generation module 105 may map relationships between the entities and may generate knowledge triplets based on the relational verb dictionary generated by the relational verb dictionary generation module 104. A knowledge triplet may include a subject, a predicate, and an object. That is, the knowledge triplet generation module 105 may generate a knowledge triplet that includes (i) a first main entity (e.g., the subject) and a second main entity (e.g., the object) among the main entities and (ii) a cluster name/identifier indicating a relationship between the first main entity and the second main entity based on the relational verb dictionary.

In some embodiments, if a verb indicating a relationship between a first main entity and a second main entity is included in the relational verb dictionary when the knowledge triplet for the main entities (previously extracted by the main entity extraction module 102) is generated, a cluster to which the verb belongs may be indicated in the relational verb dictionary. Thus, the knowledge triplet generation module 105 may generate the knowledge triplet to also include the cluster name (or other identifier) designated for the triplet's verb in the relational verb dictionary.

In contrast, if the verb indicating the relationship between the first entity and the second entity does not have a cluster classification/identifier in the relational verb dictionary, there is no cluster of the relational verb dictionary to which the verb belongs. As the knowledge triplet generation module 105 cannot generate the knowledge triplet to include a cluster name from the relational verb dictionary, instead, the knowledge triplet generation module 105 may obtain a cluster name for the non-clustered verb by injecting a few-shot prompt into the LLM, and may generate the knowledge triplet using the thus-obtained cluster name. To this end, the knowledge triplet generation module 105 may generate a prompt for the few-shot prompt.

Few-shot prompting is a technique used with LLMs in the field of natural language processing, and may provide a minimum example (i.e., a shot or attempt) so that the model performs a specific task. The few-shot prompting may be facilitated by pre-training the LLM with large data and then enabling the LLM to understand and perform the specific task with only a very small number of examples.

Specifically, first, the knowledge triplet generated by the knowledge triplet generation module 105 (and lacking a cluster) may be stored and managed in the knowledge triplet database 21. For example, the knowledge triplet database 21 may be implemented as either (i) a graph database storing data based on a graph structure in which the triplet (including the subject, the predicate/verb, and the object) is expressed as a graph node and an edge, or (ii) as a resource description framework (RDF) triple store that stores data in a triplet structure of the subject, the predicate, and the object, or (iii) may be implemented as a document-oriented database, a relational database, or a hybrid database implemented by a combination of at least two of the foregoing, as non-limiting examples.

If the verb of the generated knowledge triplet is not included in the relational verb dictionary (or is in the verb dictionary but has no designated cluster), the knowledge triplet generation module 105 may calculate first similarities between the third entity of the triplet and head nodes (first entities) of second knowledge triplets stored in the knowledge triplet database (e.g., as first respective multidimensional vectors). In addition, the knowledge triplet generation module 105 may calculate second similarities between the fourth entity of the triplet and tail nodes (second entities) of the knowledge triplets stored in the knowledge triplet database (e.g., as second multidimensional vectors), in the same method as the method used to calculate the first similarities.

Multidimensional vectors may be any of various possible methods for quantifying a meaning of a word in natural language processing to express the meaning so that a computer “understands” the meaning, and may represent/encode the word as a point within a multidimensional vector space through design vectorization, thus allowing semantic similarities between words to be determined. For example, the conversion to the multidimensional vector may be performed using a static language expression method such as Word2Vec, GloVe, or FastText. A Word2Vec model may be trained from words around a word (e.g., with word vicinities) so that words used in a similar context have close vectors (here “close” may be according to any vector distance calculation), and may utilize a distributional characteristic of the words so that words with similar meanings are disposed close to each other in the corresponding vector space. GloVe may generate a vector by training a co-occurrence probability between words based on large global statistical data, may globally reflect a relationship between the words, and may represent a linear semantic relationship in a vector space. FastText may better reflect a similarity between words with similar shapes by training not only the word itself but also a character n-gram inside the word. Because a static language expression method expresses a word with the same vector in all contexts when a single training is performed, the static language expression method may provide an expression of a word with a fixed meaning, may reflect a subtle semantic difference between words because the training is performed in a large text corpus, and may be useful in various natural language processing tasks such as similarity calculation, clustering, and classification.

A method of calculating the similarities may include, as non-limiting examples, either (i) a method of calculating a cosine similarity that measures the similarity by calculating a cosine angle between two vectors or (ii) a Euclidean distance that measures the similarity by calculating a straight-line distance between two vectors. Other methods of calculating similarity may be used, for example by calculating a dot product that measures the similarity by multiplying component of the two vectors and summing the multiplied components, a Manhattan distance that measures the similarity by calculating a distance obtained by adding absolute values of differences between the two vectors, or a Jaccard similarity that measures the similarity by considering an element of the vector as a set and dividing a size of an intersection between two sets by a size of a union of the two sets.

Next, the knowledge triplet generation module 105 may designate, as a few-shot example, from among the knowledge triplets stored in the knowledge triplet database, a knowledge triplet whose corresponding first similarity (head similarity) and second similarity exceed a predetermined threshold value. The few-shot example may be added to the few-shot prompt (i.e., the few-shot example may be inserted into the few-shot prompt of the non-clustered knowledge triplet).

In some embodiments, to designate the few-shot example, the knowledge triplet generation module 105 may designate the top-K knowledge triplets whose first similarity and second similarity exceed the predetermined threshold value; the top-K knowledge triplets may be ordered according to the sums of their first and similarities (highest to lowest) and the knowledge triplets with the top-K similarity sums may be included in the few-shot example.

In some other embodiments, the knowledge triplet generation module 105 may select a representative example triplet from each cluster of knowledge triplets stored in the knowledge triplet database, and may add the representative example to the few-shot prompt together with the few-shot example (i.e., may insert the representative example together with the few-shot example into the prompt for the few-shot prompting).

The knowledge triplet generation module 105 may assign a relationship to an unclassified/unclustered verb by inputting the few-shot prompt to the LLM which infers therefrom the relationship/class of the previously unclassified verb, and may thus complete the triplet. The triplet finally completed through the above process may be stored in the knowledge triplet database along with those that were selected from (and labeled according to) the clusters.

As described next, the knowledge map generation module 106 may generate the knowledge map based on the knowledge triplets generated by the knowledge triplet generation module 105. The knowledge map generation module 106 may record the generated knowledge map in the storage medium of the knowledge map generation device 10. In some embodiments, the knowledge map may be stored in the storage medium of the knowledge map generation device 10 as various types of data structures such as a graph, a tree, a matrix, a list, an array, or the like.

In some embodiments/implementations, it may be possible to build a knowledge ontology and a relational knowledge map by extracting the main entities from the technical document having a characteristic in which the main terms are mainly described in a phrase unit, extracting the verbs indicating main relationships between the main entities, and structuring the main relationships between the entities based on the extracted main verbs. Knowledge specific to the specific field (in which a knowledge ontology may not be available) may be extracted through a method in which the relationships between the entities are mapped so that the knowledge triplets are generated.

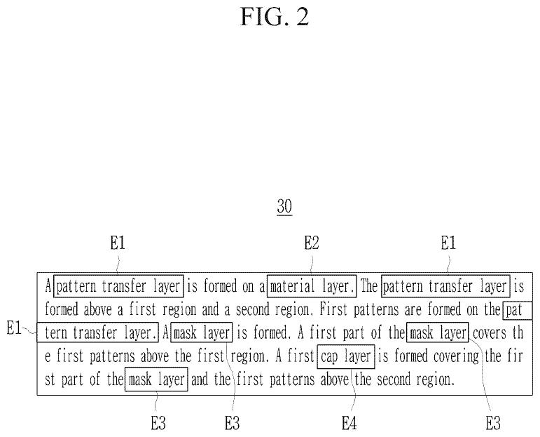

FIGS. 2 to 7 show a detailed process of generating a knowledge map according to one or more embodiments.

FIG. 2 shows an example 30 of extracting main entities (which may be in a unit of a phrase or the like) by applying the key-phrase-extraction language model to the document having a characteristic describing the main terms in a phrase unit (or the like). As a result of applying the key-phrase-extraction language model to the example document shown in part in FIG. 2, it may be seen that a first main entity E1 (“pattern transfer layer”), a second main entity E2 (“material layer”), a third main entity E3 (“mask layer”), and a fourth main entity E4 (“cap layer”) are extracted as the main entities.

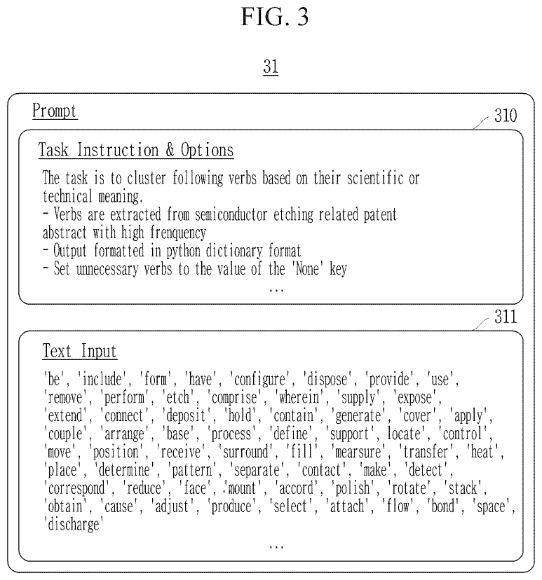

FIG. 3 shows an example 31 of the prompt injected into the LLM to cluster the extracted relational verbs into clusters representing a relational unit by performing dependency parsing on a sentence including the main entities E1 to E4. The prompt may be generated to include an item 310 that is task instruction and options thereof and an item 311 that is a text input including verbs whose frequency is higher than a predetermined number among the extracted verbs by performing the dependency parsing.

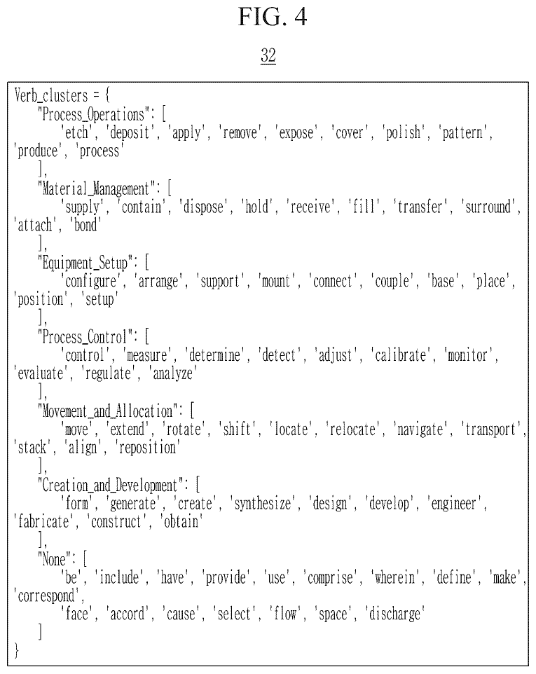

FIG. 4 shows an example 32 of building the relational verb dictionary based on the LLM. In the relational verb dictionary, it may be seen that “Process_Operations”, “Material_Management”, “Equipment_Setup”, “Process_Control”, “Movement_and_Allocation”, “Creation_and_Development”, and “None” are designated as cluster names. Verbs described to belong to the cluster name that is “None” may be verbs that are not clustered into any relational unit.

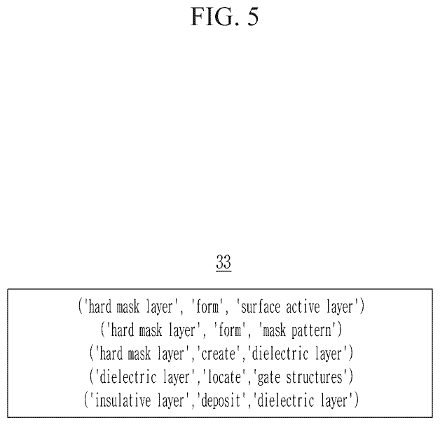

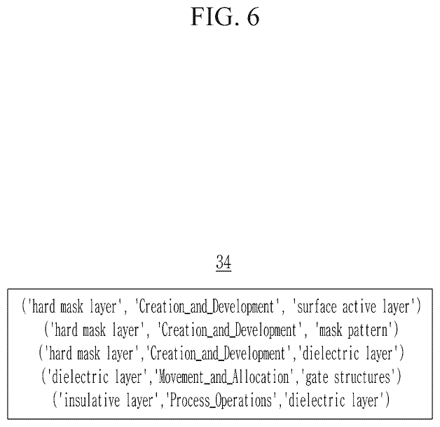

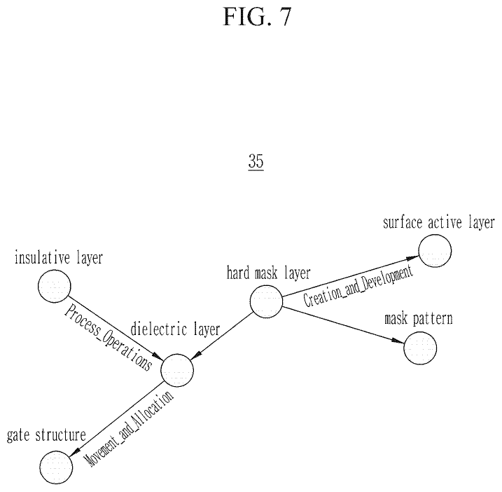

FIG. 5 shows an example 33 of triplets in a form of “(entity, relational verb, entity)” before the knowledge triplets are generated using the cluster name designated in the relational verb dictionary for the main entities. FIG. 6 shows an example 34 of the knowledge triplets in the form of “(entity, cluster name, entity)” generated using the cluster name designated to be derived from the relational verb dictionary for the knowledge triplet in the form shown in FIG. 5. FIG. 7 shows an example 35 of the knowledge map generated based on the knowledge triplet shown in FIG. 6. A node of “insulative layer” and a node of “dielectric layer” may be connected by an edge of “Process_Operations”, and a node of “dielectric layer” and a node of “gate structure” may be connected by an edge of “Movement_and_Allocation”. A node of “hard mask layer” may be connected to a node of “dielectric layer”, a node of “mask pattern”, and a node of “surface active layer” via an edge of “Creation_and_Development”.

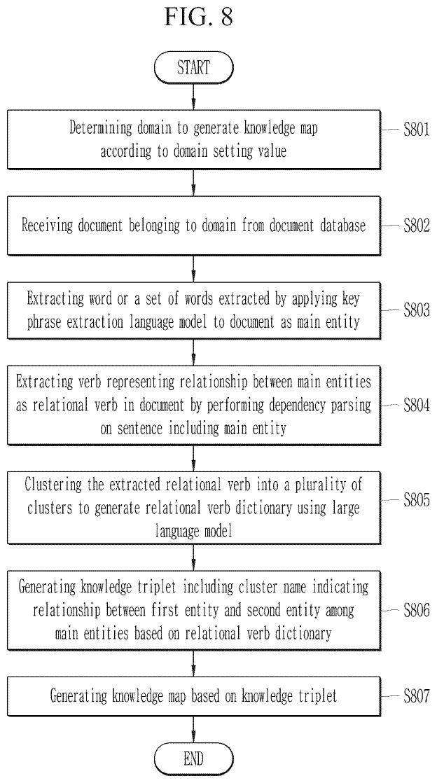

FIG. 8 shows a method for generating the knowledge map according to one or more embodiments.

Referring to FIG. 8, the knowledge map generation method according to the embodiment may include a step of determining a domain to generate the knowledge map according to the domain setting value (S801), a step of receiving a document selected as belonging to the domain from the document database (S802), a step of extracting a word or a set of words by applying the key-phrase-extraction language model to the document (the extracted words being the main entities) (S803), a step of extracting a verb representing a relationship between the main entities as the relational verb in the document by performing dependency parsing on a sentence including the main entity (S804), a step of clustering the extracted relational verb into a plurality of clusters to generate the relational verb dictionary using the large language model (S805), a step of generating a knowledge triplet including the cluster name indicating a relationship between the first entity and the second entity among the main entities based on the relational verb dictionary (S806), and a step of generating the knowledge map based on the knowledge triplet (S807).

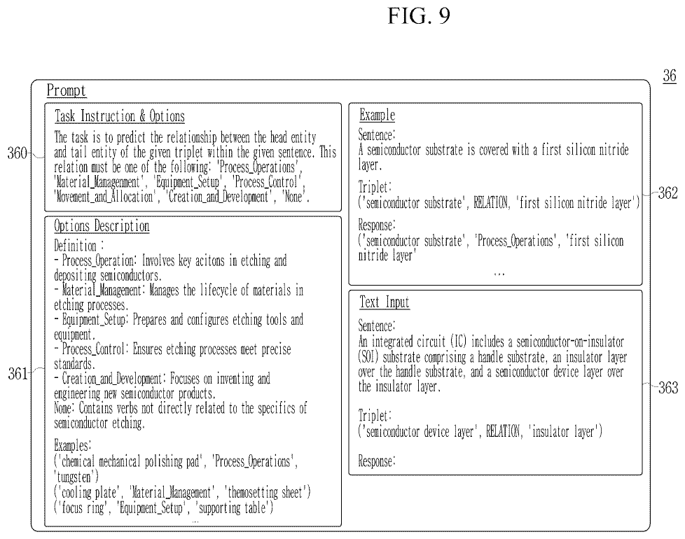

FIG. 9 shows a detailed process of generating the knowledge map according to one or more embodiments.

FIG. 9 shows an example 36 of the prompt for the few-shot prompting that is injected into the LLM to obtain a new cluster name if the verb is not classified in the relational verb dictionary. The prompt may be generated to include an item 360 that is a task instruction and options thereof, an item 361 that includes descriptions of the representative examples of the respective clusters as selected from the knowledge triplet stored in the knowledge triplet database, a few-shot example 362 in which the first similarity with the entity corresponding to the head node and the second similarity with the entity corresponding to the tail node exceed the predetermined threshold value in the knowledge triplet stored in the knowledge triplet database, and an item 363 that is a text input.

For example, in the item 361, the representative example for each cluster may include (“chemical mechanical polishing pad”, “Process_Operations”, “tungsten”), (“cooling plate”, “Material_Management”, “thermosetting sheet”), (“focus ring”, “Equipment_Setup”, “supporting table”), and the like. For example, K knowledge triplets each with a large sum of similarities may be selected among knowledge triplets with high similarities based on the similarity of each entity, and the selected knowledge triplets may be included in the item 362.

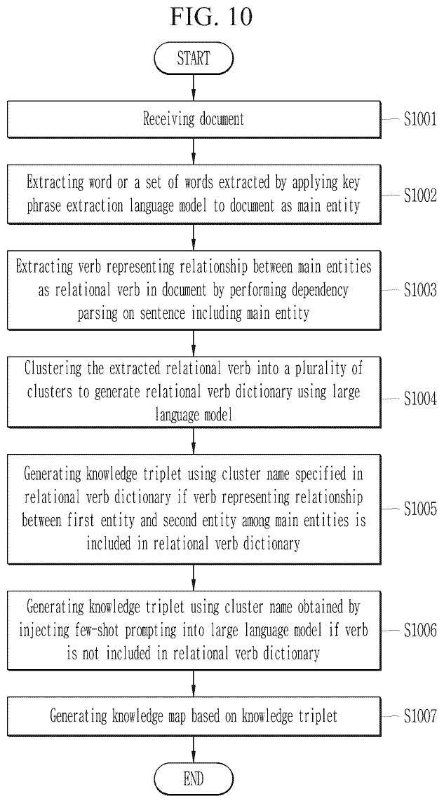

FIG. 10 shows a method for generating the knowledge map according to one or more embodiments.

Referring to FIG. 10, the knowledge map generation method according to the embodiment may include a step of receiving the document (S1001), a step of extracting a word or a set of words extracted by applying the key phrase extraction language model to the document as the main entity (S1002), a step of extracting a verb representing a relationship between the main entities as the relational verb in the document by performing dependency parsing on a sentence including the main entity (S1003), a step of clustering the extracted relational verb into a plurality of clusters to generate the relational verb dictionary using the large language model (S1004), a step of generating a knowledge triplet using the cluster name specified (or designated) in the relational verb dictionary if the verb representing a relationship between the first entity and the second entity among the main entities is included in the relational verb dictionary (S1005), a step of generating a knowledge triplet using the cluster name obtained by injecting the few-shot prompting into the large language model if the verb is not included in the relational verb dictionary (S1006), and a step of generating the knowledge map based on the knowledge triplet (S1007).

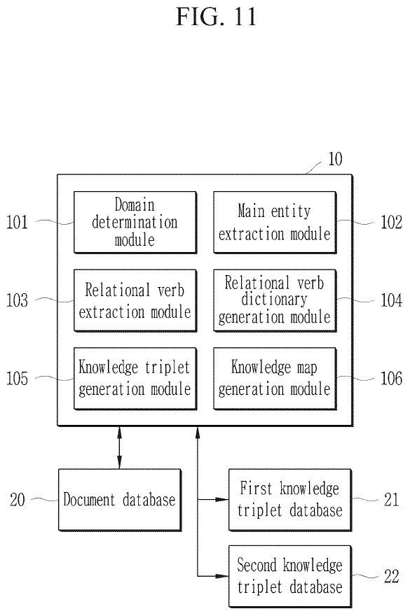

FIG. 11 shows a device for generating the knowledge map according to one or more embodiments.

Referring to FIG. 11, the knowledge map generation device 10 according to the embodiment may include a domain determination module 101, a main entity extraction module 102, a relational verb extraction module 103, a relational verb dictionary generation module 104, a knowledge triplet generation module 105, and a knowledge map generation module 106. Because descriptions of the domain determination module 101, the main entity extraction module 102, the relational verb extraction module 103, the relational verb dictionary generation module 104, the knowledge triplet generation module 105, and the knowledge map generation module 106 are applied to the above description with respect to FIG. 1 to an extent not contradicting that described below with respect to FIG. 11, a difference between the embodiment according to FIG. 11 and the embodiment according to FIG. 1 will be mainly described.

The domain determination module 101 may read that the domain setting value is a first value representing the thesis domain, and may determine the domain in which the knowledge map is to be generated as the thesis domain according to the first value. The main entity extraction module 102 may extract the main entity by applying a first key phrase extraction language model that is trained to extract a key phrase from the document belonging to the thesis domain to the document. The relational verb extraction module 103 may perform dependency parsing on a sentence including the main entity in the document belonging to the thesis domain, may extract the verb representing a relationship between the main entities as the relational verb, and the relational verb dictionary generation module 104 may generate a first relational verb dictionary by clustering the relational verb extracted by the relational verb extraction module 103 into a plurality of clusters. The knowledge triplet generation module 105 may store a first knowledge triplet generated based on the first relational verb dictionary based on the main entity extracted in relation to the thesis domain in a first knowledge triplet database 21.

The domain determination module 101 may read that the domain setting value is a second value representing the patent document domain, and may determine the domain in which the knowledge map is to be generated as the patent document domain according to the second value. The main entity extraction module 102 may extract the main entity by applying a second key phrase extraction language model trained to extract a key phrase from the document belonging to the patent document domain to the document. The relational verb extraction module 103 may perform dependency parsing on a sentence including the main entity in the document belonging to the patent document domain, may extract the verb representing a relationship between the main entities as the relational verb, and the relational verb dictionary generation module 104 may generate a second relational verb dictionary by clustering the relational verb extracted by the relational verb extraction module 103 into a plurality of clusters. The knowledge triplet generation module 105 may store a second knowledge triplet generated based on the second relational verb dictionary based on the main entity extracted in relation to the patent document domain in a second knowledge triplet database 22.

The knowledge map generation module 106 may generate the knowledge map based on the first knowledge triplet database 21 if the domain in which the knowledge map is to be generated is the thesis domain, and the knowledge map generation module 106 may generate the knowledge map based on the second knowledge triplet database 22 rather than the first knowledge triplet database 21 if the domain in which the knowledge map is to be generated is the patent document domain.

FIG. 12 shows a computing device according to one or more embodiments.

Referring to FIG. 12, the knowledge map generation method and device according to embodiments may be implemented using the computing device 50.

The computing device 50 may include a processor 510, a memory 530, a user interface input device 540, a user interface output device 550, and a storage device 560 that communicate through a bus 520. The computing device 50 may also include a network interface 570 electrically connected to a network 40. The network interface 570 may transmit or receive a signal with another entity via the network 40.

The processor 510 may be implemented in various types such as a microcontroller unit (MCU), an application processor (AP), a central processing unit (CPU), a graphics processing unit (GPU), a neural processing unit (NPU), and/or a quantum processing unit (QPU), and may be any semiconductor device that executes a command stored in the memory 530 or the storage device 560. The processor 510 may be configured to implement the functions and the methods described above with respect to FIGS. 1 to 11.

The memory 530 and the storage device 560 may include various types of volatile or non-volatile storage media. For example, the memory may include a read-only memory (ROM) 531 and a random access memory (RAM) 532. In some embodiments, the memory 530 may be disposed inside or outside the processor 510, and may be connected to the processor 510 through various known means (or various known devices).

In some embodiments, at least some components or functions of the knowledge map generation method and device may be implemented as a program or software executed in the computing device 50, and the program or software may be stored in a computer-readable medium. Specifically, the computer-readable medium according to an embodiment may be a medium in which a program for executing steps included in implementation of the knowledge map generation method and device according to the embodiments is recorded in a computer including the processor 510 executing a program or a command stored in the memory 530 or the storage device 560.

In some embodiments, at least some components or functions of the knowledge map generation method and device may be implemented using hardware or a circuit of the computing device 50, or may be implemented as a separate hardware or circuit capable of being electrically connected to the computing device 50.

According to some embodiments, it may be possible to provide an efficient method capable of building a knowledge ontology and a relational knowledge map by automatically extracting knowledge specific to the specific field in which a knowledge ontology is not available. Some of the embodiments may reduce a time and a cost by minimizing a need for manual labeling and efficiently generating the knowledge map using an automated method. Furthermore, some of the embodiments may build the knowledge map specific to each domain to increase usability of information in the specific field, and may provide a foundation for systematic management and analysis of knowledge in various application fields.

The computing apparatuses, the electronic devices, the processors, the memories, the displays, the information output system and hardware, the storage devices, and other apparatuses, devices, units, modules, and components described herein, including descriptions with respect to respect to FIGS. 1-12, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1—that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A method for generating a knowledge map, comprising:
determining a domain to generate the knowledge map;
receiving a document selected as belonging to the determined domain from a document database;
extracting, as main entities, a set of words from the received document by applying a key-phrase-extraction language model to the document;
extracting, as a relational verb, from the received document, a verb representing a relationship between the main entities by performing dependency parsing on a sentence including the main entities;
clustering, by a large language model, the extracted relational verb into a clusters to generate a relational verb dictionary;
generating a knowledge triplet including a first entity and a second entity among the main entities and a cluster identifier of one of the clusters, the cluster identifier indicating a relationship between the first entity and the second entity based on the relational verb dictionary;
generating the knowledge map based on the knowledge triplet; and
recording the generated knowledge map in the storage medium.

2. The method of claim 1, wherein the generating the knowledge triplet using the cluster identifier designated in the relational verb dictionary is performed based on the verb indicating that the relationship between the first entity and the second entity is included in the relational verb dictionary;
and wherein the method further comprises:
extracting a second relational verb from the sentence in the received document, the second verb representing a second relationship between a third main entity and a fourth main entity among the main entities; and
generating a second knowledge triplet used to generate the knowledge map by using a cluster identifier obtained by inputting a few-shot prompt into the large language model based on the second verb indicating that the second relationship between the third and fourth entities is not included in the relational verb dictionary.

3. The method of claim 2, wherein the generated knowledge triplet and the second knowledge triplet are stored in a knowledge triplet database, and
the generating of the second knowledge triplet using the cluster identifier obtained by inputting the few-shot prompt into the large language model based on the second verb indicating the relationship between the third and fourth entities is not included in the relational verb dictionary comprises:
calculating a first similarity between the third entity and an entity of a head node of a second knowledge triplet stored in the knowledge triplet database,
calculating a second similarity between the fourth entity and an entity of a tail node of the second knowledge triplet stored in the knowledge triplet database,
designating the second knowledge triplet as a few-show example based on the first similarity and the second similarity exceeding a predetermined threshold value, and
adding the few-shot example to the few-shot prompt.

4. The method of claim 3, wherein the designating of the second knowledge triplet as the few-shot example comprises:
designating K knowledge triplets in which the first similarity and the second similarity exceed a predetermined threshold value and a sum of the first similarity and the second similarity is selected in a descending order among the knowledge triplets stored in the knowledge triplet database as a few-shot example.

5. The method of claim 3, wherein the adding of the few-shot example to the few-shot prompt comprises:
selecting a representative example for each cluster from the knowledge triplet stored in the knowledge triplet database; and
adding the representative examples to the few-shot prompt together with the few-shot example.

6. The method of claim 1, wherein the document is preprocessed by tokenization that separates the document into tokens that are a minimum unit of analysis based on an individual sentence, an individual word, and a subword and lemmatization that converts words of the document into a basic form.

7. The method of claim 1, wherein the determining of the domain comprises:
determining that a domain setting value is a first value representing a first domain among multiple domains and determining the first domain to generate the knowledge map as the first domain according to the first value, and the extracting of the word or the set of words as the main entities comprises extracting the main entities by applying a first key-phrase-extraction language model that is trained to extract a key phrase from the document belonging to the first domain to the document.

8. The method of claim 7, wherein the determining of the domain comprises:
determining that the domain setting value is a second value representing a second domain and determining the second domain to generate the knowledge map as the second domain according to the second value, and
the extracting of the word or the set of words as the main entity comprises:
extracting the main entities by applying a second key-phrase-extraction language model that is trained to extract a key phrase from the document belonging to the second domain to the document.

9. The method of claim 8, wherein the generating of the knowledge triplet comprises:
storing a first knowledge triplet generated based on a first relational verb dictionary based on the main entities extracted in relation to the first domain in a first knowledge triplet database; and
storing a second knowledge triplet generated based on a second relational verb dictionary based on the main entities extracted in relation to the second domain in a second knowledge triplet database.

10. The method of claim 9, wherein the generating of the knowledge map comprises:
generating the knowledge map based on the first knowledge triplet database if the domain in which the knowledge map is to be generated is the first domain; and
generating the knowledge map based on the second knowledge triplet database if the domain in which the knowledge map is to be generated is the second domain.

11. A method for generating a knowledge map, comprising:
receiving a document through an input/output interface of a computing device;
extracting, as main entities, a set of words from the received document by applying a key-phrase-extraction language model to the document;
extracting, as a relational verb, from the received document, a first verb representing a first relationship between the main entities and a second verb representing a second relationship between the main entities by performing dependency parsing on a sentence including the main entities;
clustering, by a large language model, the extracted relational verbs into clusters to generate a relational verb dictionary;
generating a first knowledge triplet using a first cluster identifier designated in the relational verb dictionary based on a first verb indicating a first relationship between a first entity and a second entity among the main entities being included in the relational verb dictionary;
generating a second knowledge triplet using a second cluster identifier obtained by inputting a few-shot prompt into the large language model based on the verb indicating the second relationship between a third entity and a fourth entity among the entities is not included in the relational verb dictionary;
generating the knowledge map based on the knowledge triplet; and
recording the generated knowledge map in a storage medium of the computing device.

12. The method of claim 11, wherein the generated knowledge triplet is stored in a knowledge triplet database, and
the generating of the second knowledge triplet using the second cluster identifier obtained by inputting the few-shot prompt into the large language model based on the second verb indicating the second relationship between the third entity and the fourth entity is not included in the relational verb dictionary comprises:
calculating a first similarity between the third entity and an entity of a head node of a knowledge triplet stored in the knowledge triplet database,
calculating a second similarity between the fourth entity and an entity of a tail node of the knowledge triplet stored in the knowledge triplet database,
designating, as a few-shot example, the knowledge triplet in which the first similarity and the second similarity exceed a threshold value among knowledge triplets stored in the knowledge triplet database, and
adding the few-shot example to the few-shot prompt.

13. The method of claim 12, wherein the designating of the knowledge triplet as the few-shot example comprises:
designating K knowledge triplets in which the first similarity and the second similarity exceed a predetermined threshold value and a sum of the first similarity and the second similarity is selected in a descending order among the knowledge triplets stored in the knowledge triplet database as a few-shot example.

14. The method of claim 12, wherein the adding of the few-shot example to the few-shot prompting comprises:
selecting representative examples for the respective clusters from the knowledge triplets stored in the knowledge triplet database; and
adding the representative examples to the few-shot prompt together with the few-shot example.

15. The method of claim 11, wherein the document is preprocessed by tokenization that separates the document into tokens that are a minimum unit of analysis based on an individual sentence, an individual word, and a subword and lemmatization that converts words of the document into a basic form.

16. A device for generating a knowledge map, comprising:
one or more memory devices; and
one or more processors that generate the knowledge map by executing instructions stored in the one or more memory devices,
wherein the instructions are executed to cause, by the device,
determining a domain to generate the knowledge map,
receiving a document selected from a document database based on belonging to the domain,
extracting, as main entities, a set of words by applying a key-phrase-extraction language model to the document,
extracting a verb representing a relationship between main entities as a relational verb in the document by performing dependency parsing on a sentence including the main entities,
clustering, by the large language model, the extracted relational verbs into clusters to generate a relational verb dictionary,
generating a knowledge triplet including a first entity and a second entity among the main entities and a cluster identifier indicating a relationship between the first entity and the second entity based on the relational verb dictionary,
generating the knowledge map based on the knowledge triplet, and
recording the generated knowledge map in the storage medium are performed.

17. The device for generating the knowledge map of claim 16, wherein the generating the knowledge triplet using the cluster identifier designated in the relational verb dictionary is performed based on the verb indicating that the relationship between the first entity and the second entity is included in the relational verb dictionary;
and wherein the instructions further cause:
extracting a second relational verb from the sentence in the received document, the second verb representing a second relationship between a third main entity and a fourth main entity among the main entities; and
generating a second knowledge triplet used to generate the knowledge map by using a cluster identifier obtained by inputting few-shot prompt into the large language model based on the second verb indicating that the second relationship between the third and fourth entities is not included in the relational verb dictionary.

18. The device for generating the knowledge map of claim 17, wherein the generated knowledge triplet and the second knowledge triplet are stored in a knowledge triplet database, and
the generating of the second knowledge triplet using the cluster identifier obtained by inputting the few-shot prompt into the large language model based on the second verb indicating the relationship between the third and fourth entities is not included in the relational verb dictionary comprises:
calculating a first similarity between the third entity and an entity of a head node of a second knowledge triplet stored in the knowledge triplet database,
calculating a second similarity between the fourth entity and an entity of a tail node of the second knowledge triplet stored in the knowledge triplet database,
designating the second knowledge triplet as a few-show example based on the first similarity and the second similarity exceeding a predetermined threshold value, and
adding the few-shot example to the few-shot prompt.

19. The device for generating the knowledge map of claim 18, wherein the designating of the second knowledge triplet as the few-shot example comprises:
designating K knowledge triplets in which the first similarity and the second similarity exceed a predetermined threshold value and a sum of the first similarity and the second similarity is selected in a descending order among the knowledge triplets stored in the knowledge triplet database as a few-shot example.

20. The device for generating the knowledge map of claim 18, wherein the adding of the few-shot example to the few-shot prompt comprises:
selecting a representative example for each cluster from the knowledge triplet stored in the knowledge triplet database; and
adding the representative examples to the few-shot prompt together with the few-shot example.
